(19) United States
(12) Patent Application Publication
(10) Pub. No.: US 2022/0174126 A1
(43) Pub. Date: Jun. 2, 2022

(54) DATA TRANSMITTING APPARATUS, CONTROL METHOD THEREOF, AND STORAGE MEDIUM

(71) Applicant: CANON KABUSHIKI KAISHA, Tokyo (JP)

(72) Inventor: Kaori Nakagawa, Chiba (JP)

(21) Appl. No.: 17/510,446

(22) Filed: Oct. 26, 2021

(30) Foreign Application Priority Data
Dec. 2, 2020 (JP) 2020-200506

(51) Int. Cl. H04L 29/08; H04N 1/00

(52) U.S. Cl. CPC H04L 67/24; H04N 1/00217; H04N 2201/3208; H04N 1/00212; H04L 67/22

(57) ABSTRACT

This data transmitting apparatus transmits an approval request for transmission of data and then transmits the data on the basis of receiving an approval response approving the transmission of the data as a response to the transmitted approval request. This data transmitting apparatus changes a destination of the approval request based on presence information of an approver who approves the transmission of the data.

### BACKGROUND OF THE INVENTION

### Field of the Invention

The present invention relates to a data transmitting apparatus, a control method thereof, and a storage medium.

### Description of the Related Art

Information systems, such as networks and communication apparatuses, are indispensable to the operation of companies and organizations. However, risks of information systems such as loss due to the suspension of the information system and damage and loss of credibility due to information leakage cause significant damage and impact on enterprises and organizations. This damage and impact also affect related parties such as customers and business partners.

Fax machines, which are connected to public telephone lines and can easily transmit faxes by having the fax number of the recipient entered and the send button pressed, also contain the above risks of information systems. For example, there is a possibility that erroneous transmission in which transmission is made to a wrong recipient due to making an error in a recipient FAX number, information leakage due to switching documents to be transmitted, and the like may occur, and troubles due to erroneous transmission or switching documents to be transmitted actually occur.

In recent years, information security such as personal information protection and information leakage prevention has been strengthened. In financial institutions, which often fax important documents, and the like, fax transmission operations are performed after confirmation is performed by two people so as not to transmit to a wrong destination or transmit a wrong document. Such double-checking is laborious and costly. Therefore, there is a demand for a function in which a process of confirming and approving of fax transmission destinations and content of documents to be transmitted are incorporated in an electronic workflow also in MFPs (Multi Function Peripherals) with a fax function.

For example, Japanese Patent Laid-Open No. 2007-74389 proposes a technique for requesting approval by email from an approver and if an email granting approval is received from the approver, performing a fax transmission process. If an email granting approval cannot be received from the approver within a period of time, an approval request email is transmitted to a proxy approver.

However, there is the following problem in the above prior art. In the above prior art, if an approval process cannot be carried out due to an approver being absent or the like when a fax is transmitted, a procedure is such that, after a certain period of time has elapsed, approval is obtained by requesting approval from a proxy approver. In other words, a certain period of time must have elapsed before approval of a proxy can be obtained. Therefore, in the above prior art, if an approval process for the initial request for approval cannot be immediately carried out due to the approver being in a meeting, being out, or the like, it is necessary to wait for a predetermined period of time to transmit a fax, and so it takes a long time for a fax transmission job to be executed from when it is inputted. Furthermore, if a proxy is absent or the like, approval cannot be obtained.

### SUMMARY OF THE INVENTION

The present invention enables realization of a mechanism for suitably changing a destination of a request for approval in data transmission based on the presence information of an approver.

One aspect of the present invention provides a data transmitting apparatus, comprising: an approval request transmission unit configured to transmit an approval request for transmission of data; and a data transmission unit configured to transmit the data on the basis of receiving an approval response approving the transmission of the data as a response to the approval request transmitted by the approval request transmission unit, wherein the approval request transmission unit changes a destination of the approval request based on presence information of an approver who approves the transmission of the data.

Another aspect of the present invention provides a data transmitting apparatus, comprising: an acquisition unit configured to acquire presence information; and a control unit configured to change a transmission destination of data based on the presence information acquired by the acquisition unit.

Still another aspect of the present invention provides a method of controlling a data transmitting apparatus, the method comprising: transmitting an approval request for transmission of data; and transmitting the data on the basis of receiving an approval response approving the transmission of the data as a response to the transmitted approval request, wherein a destination of the approval request is changed based on presence information of an approver who approves the transmission of the data.

Yet still another aspect of the present invention provides a non-transitory storage medium operable to store a program for causing a computer to execute each process of a method of controlling a data transmitting apparatus, the method comprising: transmitting an approval request for transmission of data; and transmitting the data on the basis of receiving an approval response approving the transmission of the data as a response to the transmitted approval request, wherein a destination of the approval request is changed based on presence information of an approver who approves the transmission of the data.

Further features of the present invention will become apparent from the following description of exemplary embodiments (with reference to the attached drawings).

### BRIEF DESCRIPTION OF THE DRAWINGS

FIG. 1 is a diagram illustrating a workflow which is a comparative example and in which a fax transmission is executed after obtaining approval.

FIG. 2 is a diagram illustrating a workflow which is a comparative example and in which an approval process is not performed and so a fax transmission is not executed.

FIG. 3 is a diagram illustrating a hardware configuration of a communication apparatus and a connection state to a communication network according to an embodiment.

FIG. 4 is a diagram illustrating a table for managing email addresses and SIP URIs of approvers by user ID according to the embodiment.

FIG. 5 is an explanatory diagram illustrating examples of text in emails exchanged between the communication apparatus and an approver according to the embodiment.

FIG. 6 is a table serving as a criteria for the communication apparatus to determine feasibility of approval from a presence status of an approver according to the embodiment.

FIG. 7 is a diagram illustrating a workflow of executing a fax transmission according to the embodiment.

FIGS. 8A and 8B are a flowchart illustrating a processing procedure of executing a fax transmission according to the embodiment.

FIG. 9 is a diagram illustrating a workflow of executing a fax transmission according to the embodiment.

FIGS. 10A and 10B are a flowchart illustrating a processing procedure of executing a fax transmission according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Comparative Example

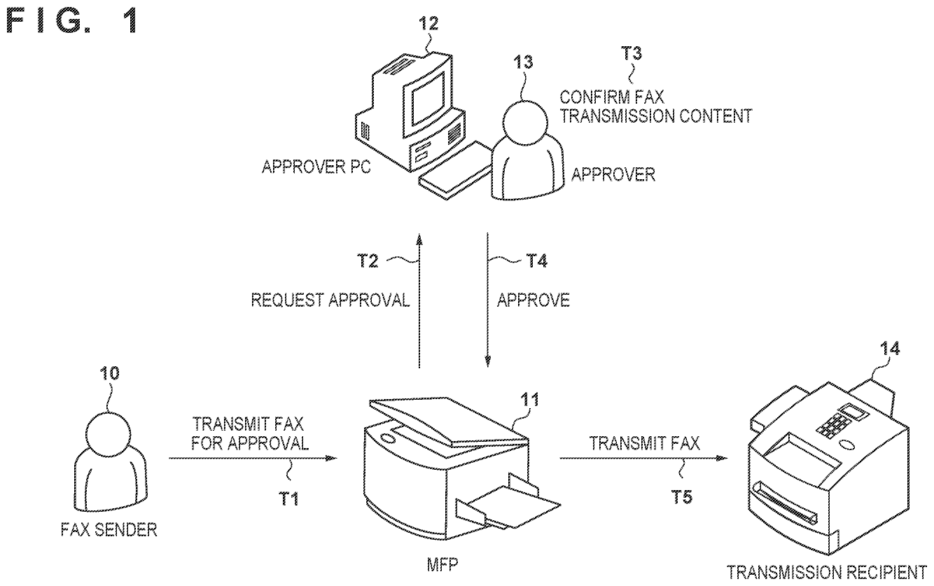

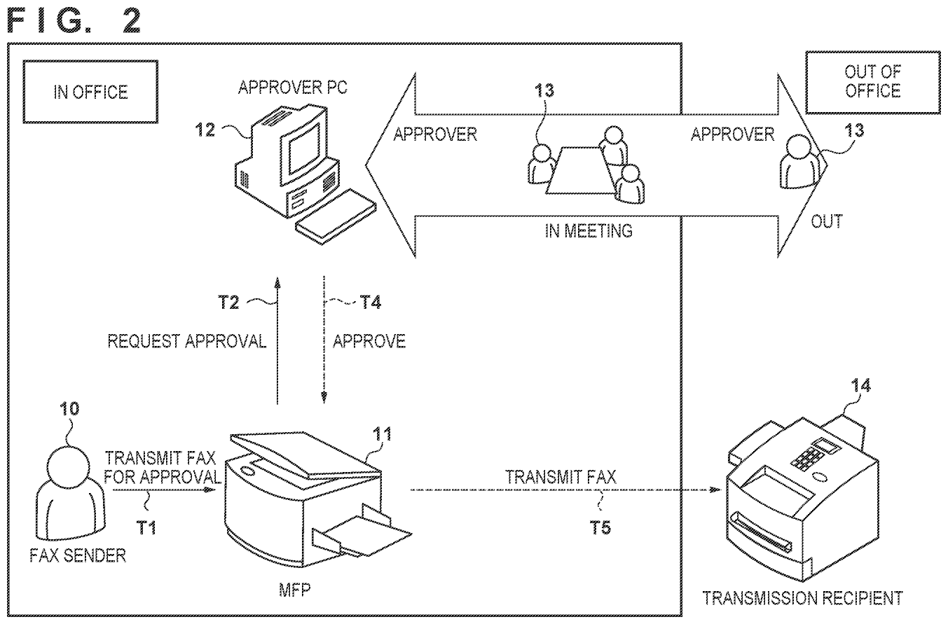

First, an approval process in a general fax transmission will be described as a comparative example of the present invention with reference to FIGS. 1 and 2. FIG. 1 is illustrates a workflow which is a comparative example and in which a fax-for-approval transmission is executed. The workflow to be described below indicates a fax-for-approval transmission in which, when transmitting a fax, a fax transmission is performed after obtaining approval of a managerial staff or an approver for a destination and a document to be transmitted. Note that, in the following, transmitting a fax after obtaining approval of an approver is referred to as a fax-for-approval transmission, a fax-for-approval transmission job, a fax-for-approval, and the like.

A reference numeral 10 denotes a fax sender, and a reference numeral 13 denotes an approver who approves a document to be transmitted by the fax sender. A reference numeral 11 denotes an image formation apparatus, and a reference numeral 12 denotes a personal computer (hereinafter abbreviated as PC) that the approver 13 uses. A reference numeral 14 denotes a reception apparatus which is a destination of a fax transmission.

First, at T1, the fax sender inputs a fax-for-approval transmission job, which requires approval for a transmission destination and a document to be transmitted, to the MFP 11. Next, at T2, the MFP 11 transmits an approval request email to which destination information and the document to be transmitted are attached to an address of an approver. Next, at T3, the approver 13 confirms and approves the transmission destination information and the document to be transmitted attached to the email via the approver PC 12. Upon obtaining approval of the approver 13, the approver PC 12 communicates approval for the fax transmission job to the MFP 11 at T4. At T5, the MFP 11 faxes the fax transmission job for which approval has been communicated to the transmission destination reception apparatus 14.

FIG. 2 illustrates a fax transmission workflow which is a comparative example and in which approval cannot be obtained. The same reference numerals and step numbers are assigned to components that are the same as those in FIG. 1, and description thereof is omitted.

As illustrated in FIG. 2, there are cases where approval processes, which are T3 and T4 illustrated in FIG. 1, are not possible due to the approver 13 being in a meeting in the office or being out of the office when the MFP 11 has transmitted an approval request email to the approver PC 12 of the approver 13. In these cases, a fax transmission (T5) cannot be executed until the approver 13 performs the approval processes, and so the fax sender 10 does not know when the fax transmission will be completed. As described above, it is also conceivable to transmit the approval request email again to another approver after a predetermined time has elapsed since transmitting the approval request email. However, even in such a control, one needs to wait for the approval of the absent approver 13 until a predetermined period of time elapses, and if the other approver is also absent, the fax sender 10 will still not know when the fax transmission will be completed.

<Configuration of Communication Apparatus>

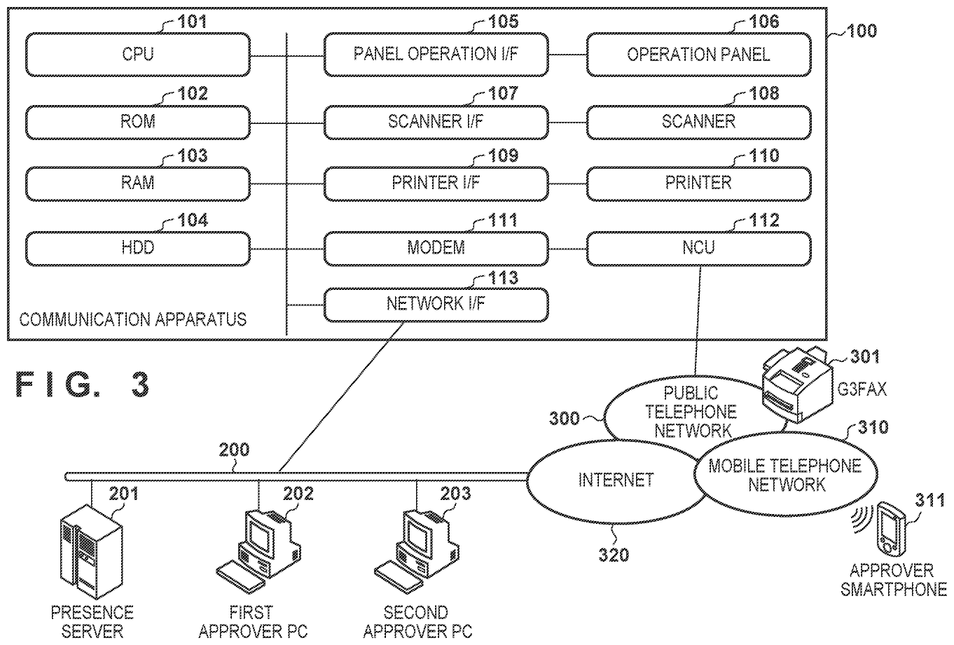

Hereinafter, an embodiment of the present invention will be described. First, a hardware configuration of a communication apparatus 100 and a connection state to a communication network according to the embodiment will be described with reference to FIG. 3.

The communication apparatus 100 includes a CPU 101, a ROM 102, a RAM 103, an HDD 104, a panel operation I/F 105, an operation panel 106, a scanner I/F 107, and a scanner 108. The communication apparatus 100 further includes a printer I/F 109, a printer 110, a modem 111, an NCU 112, and a network I/F 113.

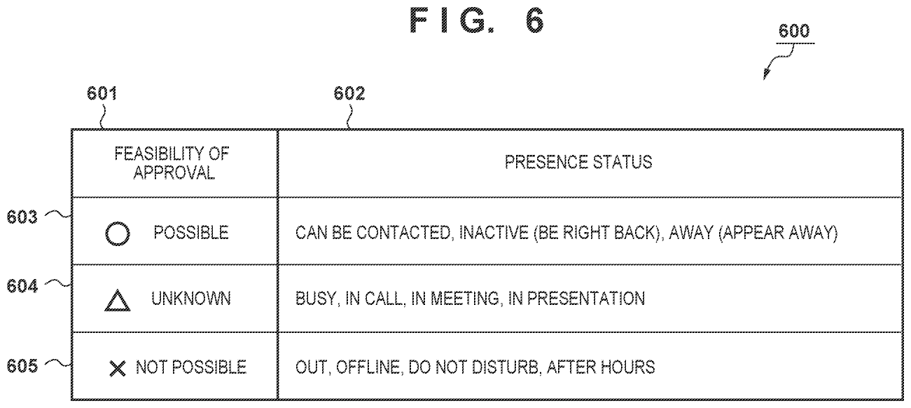

The communication apparatus 100 is connected to an intranet 200 and a public telephone network 300 via the network I/F 113. The intranet 200 is connected to, for example, a presence server 201; a first approver PC 202 and a second approver PC 203, which are fixed terminals; and the like. The presence server 201 communicates with the approver PCs 202 and 203 connected to the intranet 200 and manages the presence statuses representing the working statuses of the approvers. Details on presence statuses will be described later with reference to FIG. 6.

The communication apparatus 100 performs fax communication with a G3 FAX 301 connected to the public telephone network 300. In addition, the communication apparatus 100 is connected to the Internet 520 and a mobile telephone network 310 from the intranet 200 via a router, a GW, or the like (not illustrated) and can communicate with an approver smartphone 311, which is a mobile terminal on the mobile telephone network 310, by email or the like.

The CPU 101 comprehensively controls access to various devices connected to a system bus based on control programs stored in the ROM 102 or the hard disk drive (HDD) 104. The ROM 102 stores control programs and the like that the CPU 101 can execute. The RAM 103 mainly functions as a main memory, a work area, or the like of the CPU 101 and can expand memory capacity by an optional RAM connected to an expansion port (not illustrated). The HDD 104 stores, for example, a boot program, various applications, font data, user files, and editing files.

The panel operation I/F 105 functions as an acceptance unit and controls the display of the operation panel 106 and the input of various kinds of setting information set on the operation panel 106. The scanner I/F 107 controls the input of images from the scanner 108. The printer I/F 109 controls the output of images from the printer 110. The modem 111 demodulates fax procedure signals and image data signals from the communication channels and conversely modulates the fax procedure signals and the image data signals from the communication apparatus 100 and outputs them to the communication channels. The NCU (Network Control Unit) 112 is a communication channel control unit configured by a relay and the like and outputs selection signals by pulses or signals such as hooking to the public telephone network 300. The network I/F 113 is an expansion card, such as an NIC, for connecting the communication apparatus 100 to the network and controlling it.

<Management Table>

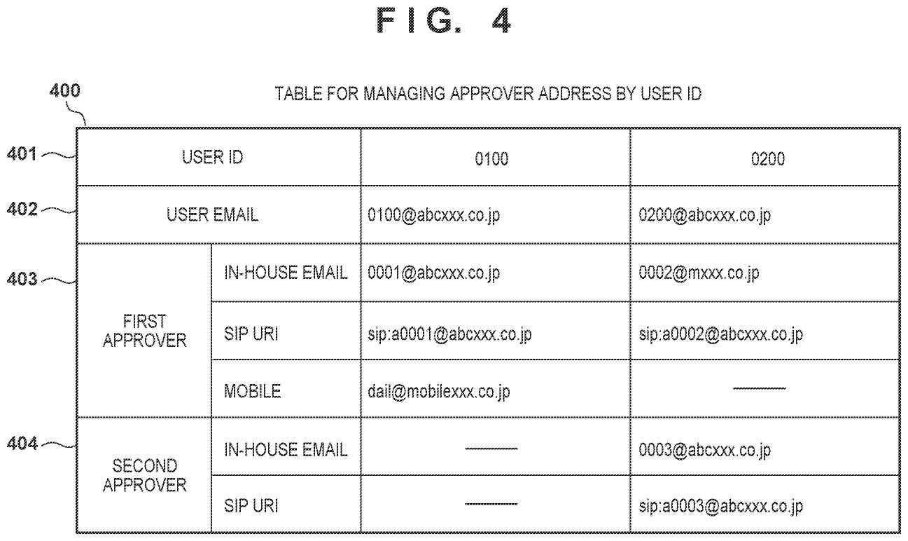

Next, a management table for managing destinations such as addresses of approvers by user registered in the communication apparatus 100 according to the embodiment will be described with reference to FIG. 4. A management table 400 is a table for managing user addresses 402, email addresses and SIP URIs of a first approver 403 and a second approver 404 by user IDs 401 registered in advance. In the management table 400, an example in which approvers from the first approver 403 to the second approver 404 can be registered will be described; however, there is no intention to limit the present invention and more approvers can be registered.

In the registration example of FIG. 4, in-house email addresses and SIP URIs can be registered for both the first approver 403 and the second approver 404. In addition, only the first approver 403 can register mobile device addresses. An SIP URI is an address for acquiring the presence of an approver from the presence server 201 and can be registered in advance for each approver. Although only the first approver 403 is registered as the approver whose user ID is “0100”, the mobile address of the first approver is registered. In addition, although the first approver 403 to the second approver 404 are registered as the approver whose user ID is “0200”, the mobile address of the first approver 403 is not registered.

<Information to be Exchanged>

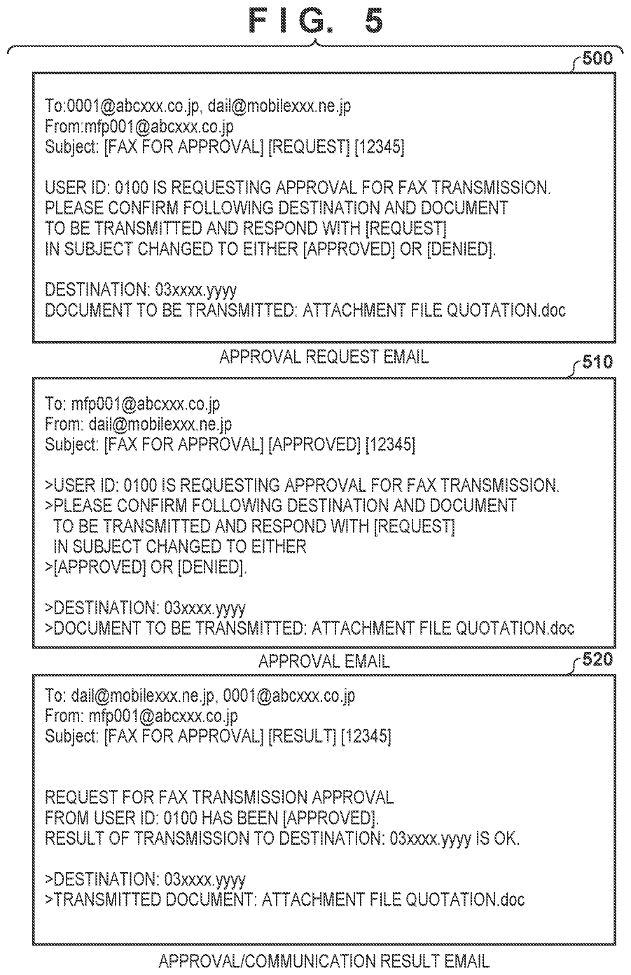

Next, information to be exchanged between the communication apparatus 100 and the apparatus that the approver holds according to the embodiment will be described with reference to FIG. 5. Although an example of exchange of information using electronic mail is described here, there is no particular intention to limit the method of exchanging information, and any method by which information to be described below can be exchanged may be used. FIG. 5 illustrates an example of each of approval request, approval, approval/communication result emails.

A reference numeral 500 indicates an example of an approval request email that the communication apparatus 100 transmits to an in-house address and a mobile address of the first approver 403. Two approver addresses are set as destinations in “To” and an email address of the communication apparatus 100, which is the transmission source, is stated in “From”. Also, a character string ([fax-for-approval] [request]) indicating that the email is an approval request email is stated in the “Subject”. In addition, a reception number ([12345]) identifying the fax transmission job that requested approval is inserted in the “Subject”. In other words, “Subject” includes email type information and information indicating that the email is an email requesting fax transmission approval.

In the body, text prompting to change the character string [request] in the “Subject” to either character string, [approved] or [denied], when replying to the email is stated. This enables the approver to choose whether to approve or deny the fax transmission. Further, destination information such as the telephone number of the transmission destination (in the figure, destination: 03xxxxyyyy) and the document to be transmitted by fax (in the figure, document to be transmitted: attachment file quotation.doc) are attached.

A reference numeral 510 denotes an example of an email responding to the approval request email 500 and in which approval is granted via the mobile address of the approver. The email address of the communication apparatus 100 is stated as the destination in “To” and the mobile address of the approver is stated in “From”. The approver has replied with the character string of the “Subject” changed to ([approved]) so as to indicate that the email is an approval email. The communication apparatus 100 can determine whether the fax transmission job corresponding to the reception number has been approved or denied based on the reception number and the character string, [approved] or [denied], in the “Subject”.

A reference numeral 520 indicates an example of an approval/communication result email which transmits a result that the transmission of the fax transmission job approved by the email in the reference numeral 510 has been successfully completed to the in-house address and the mobile address of the approver to whom the request for approval was made. All addresses of the approver to whom the approval request email was transmitted are stated as the destinations in “To”, and the email address of the communication apparatus 100 is stated in “From”. In the body, the result of the approval request (approved or denied) and the communication result (OK or not OK) of the approved fax transmission job are stated.

<Presence Status>

Next, presence statuses of the approver according to the embodiment will be described with reference to FIG. 6. A reference numeral 600 denotes a table 600 indicating a relationship between feasibility of approval 601 and presence statuses. That is, it is a table for determining whether or not the approval process is possible based on presence statuses 602 of the approvers. The table 600 is stored in advance in the HDD 104 or the like of the communication apparatus 100 and when the communication apparatus 100 has acquired the presence information of the approver, is used to determine whether or not the approver can execute the approval process. Note that the communication apparatus 100 does not need to hold such a table and may acquire information indicating whether or not the target approver can execute the approval process from the presence server 201. In this case, the presence server 201 determines whether or not the approver can execute the approval process according to the held presence information.

A presence status indicates the status of a communication partner used in instant messaging, such as SIP (Session Initiation Protocol) or Skype. Regarding the presence status of each approver, the statuses of the registered users (approvers) are periodically acquired and managed by the presence server 201. Alternatively, when a state change occurs, they may be notified to the presence server 201 by an apparatus that each approver holds and then managed in the presence server 201. They may also be acquired and managed in both. As illustrated in the reference numeral 603, the presence statuses 602 in which the feasibility of approval 601 is determined to be possible 603 includes, for example, can be contacted, inactive (be right back), and away (appear away). In addition, the presence statuses 602 in which the feasibility of approval 601 is determined to be unknown 604 includes busy, in a call, in a meeting, and in a presentation. In addition, the presence statuses 602 in which the feasibility of approval 601 is determined to be not possible 605 includes out, offline, do not disturb, and after hours. Thus, the presence statuses 602 indicate the current states of the approvers. Note that these presence statuses are examples and do not intended to limit the present invention. For example, the presence statuses 602 assigned to the above possible 603 may be assigned to another feasibility of approval 601 such as unknown 604 or not possible 605, or other presence statuses may be added. These settings can be set for associated apparatuses in the system, such as the communication apparatus 100 and the presence server 201.

### First Embodiment

### (Workflow)

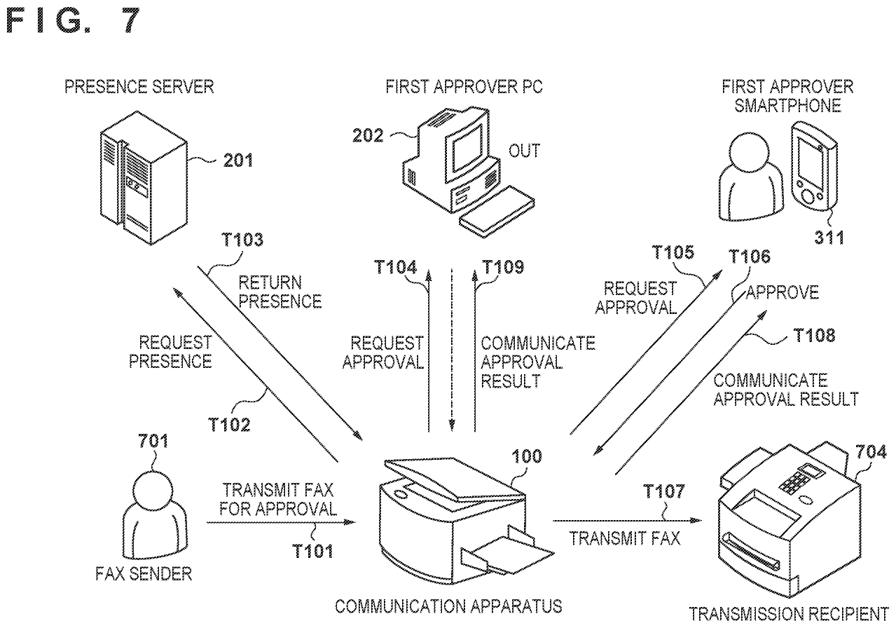

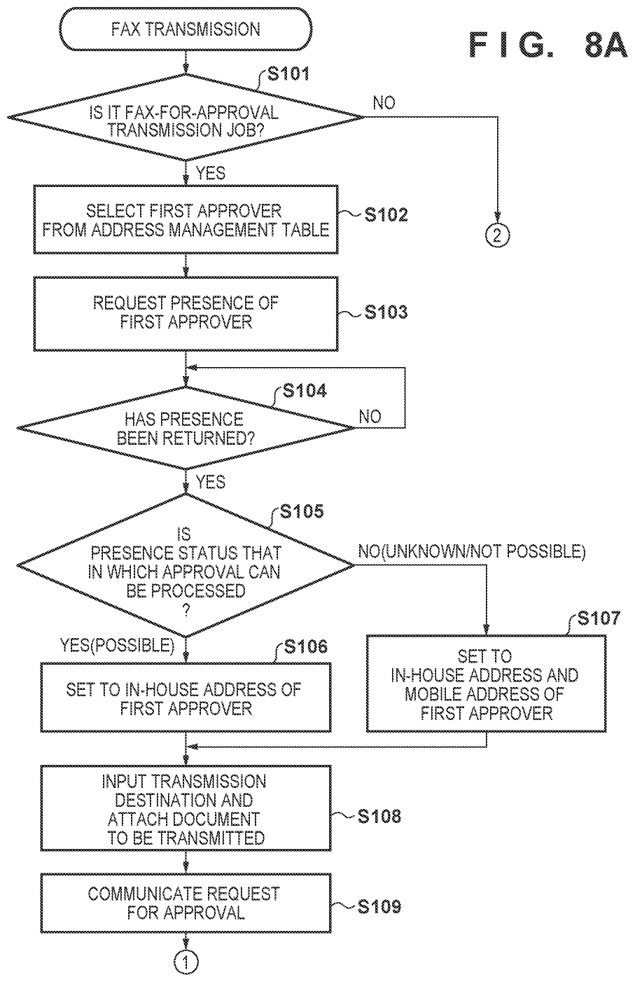

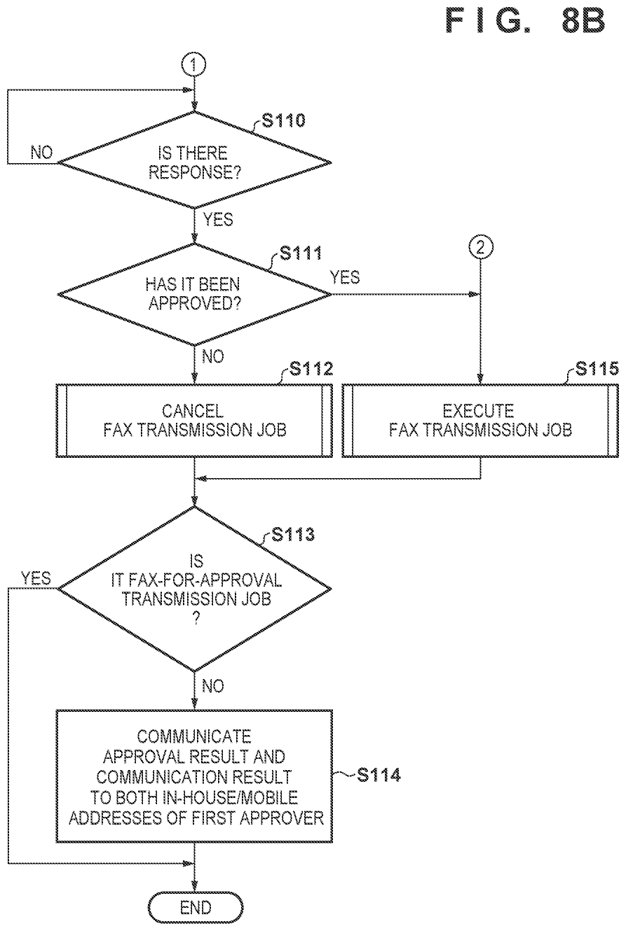

Hereinafter, the first embodiment will be described with reference to FIGS. 7 and 8. First, a workflow of a fax-for-approval transmission in the communication system according to the present embodiment will be described with reference to FIG. 7. The solid arrows illustrated in FIG. 7 represent the operations/communication that were actually performed, and a dashed line represents the operation/communication that was not performed.

First, in T101, a fax sender 701 inputs a fax-for-approval transmission job for which the transmission destination and the document to be transmitted needs to be approved to the communication apparatus 100. The FAX sender 701 may input the fax-for-approval transmission job to the communication apparatus 100 via an apparatus such as a PC or via the operation panel 106 of the communication apparatus 100. In the former case, the communication apparatus 100 accepts designation of the job and the document to be transmitted and data itself by the network I/F 113 via the intranet 200. Meanwhile, in the latter case, the communication apparatus 100 receives designation of the job and the document to be transmitted via the operation panel 106. In either case, data stored in advance in the communication apparatus 100 or data read by the scanner 108 may be used as the data to be transmitted.

Next, in T102, the communication apparatus 100 inputted with the fax-for-approval transmission job queries the presence server 201 for the presence status of an approver using the identification information of the approver. The presence server 201 acquires from the presence status of each approver being managed the presence status of the approver for whom the query has been made using the received identification information of the approver and communicates it. Subsequently, in T103, the communication apparatus 100 receives from the presence server 201 the presence status of the approver for whom the query has been made.

In T104 and T105, the communication apparatus 100 simultaneously transmits an approval request email to the in-house address of the approver and if the received presence status of the approver is out, additionally to the mobile address. That is, here, an approval request email is transmitted to the first approver smartphone 311, which is a mobile terminal, in addition to the first approver PC 202, which is a fixed terminal. Since the approver is out, the approver cannot confirm the approval request email communicated to the first approver PC 202, which is a fixed terminal. Meanwhile, the approver can confirm the approval request email received by the first approver smartphone 311, which is the mobile terminal, even when they are out and can select to approve or deny it.

When the approval email is returned from the first approver smartphone 311 by the approver in T106, the communication apparatus 100 performs a fax transmission to the transmission destination in T107. Upon completion of the fax transmission, in T108 and T109, the communication apparatus 100 communicates and shares the approval result and the fax transmission result to both the mobile address and the in-house address of the approver to whom the approval request was made.

(Processing Procedure of Communication Apparatus)

Next, a processing procedure of a fax transmission in the communication apparatus 100 according to the present embodiment will be described with reference to FIGS. 8A and 8B. The process described below is realized by, for example, the CPU 101 reading the programs stored in the ROM 102 to the RAM 103 and executing these.

In step S101, when a fax transmission job is inputted, the CPU 101 determines whether or not a fax-for-approval transmission mode was selected by the fax sender 701 when the transmission job was inputted. If the job is a normal fax transmission job that does not require approval, the process proceeds to step S115, and the CPU 101 executes the fax transmission job, determines whether or not the job is a fax-for-approval transmission job again in step S113, and then terminates the process.

Meanwhile, when it is determined that the job a fax-for-approval transmission job in step S101, the process proceeds to step S102, and the CPU 101 selects the first approver registered in the approver address management table 400 of FIG. 4 corresponding to the fax sender 701 who is logged in to the communication apparatus 100. In addition, in step S103, the CPU 101 queries the presence server 201 for the presence status of the first approver.

Next, in step S104, the CPU 101 determines whether or not a response from the presence server 201 has been received, and when it is received, proceeds to step S105, and if not, repeats the determination periodically until it is received. In step S105, the CPU 101 confirms the information on the presence status included in the response received from the presence server 201 and determines whether the first approver is in a presence status capable of the approval process using the table 600 of FIG. 6. If it is possible 603 for the first approver to execute the approval process, the process proceeds to step S106, and the CPU 101 sets the in-house address of the approver as the destination of the approval request and advances the process to step S108. Meanwhile, if it is difficult to execute the approval process (unknown 604 or not possible 605), the process proceeds to step S107, and the CPU 101 sets the mobile address as the destination of the approval request in addition to the in-house address of the first approver and advances the process to step S108. In step S108, the CPU 101 states the transmission destination information in the approval request email, attaches the document to be transmitted, and in step S109, communicates the approval request email to the address of the first approver set in step S106 or step S107.

Thereafter, in step S110, the CPU 101 determines whether there has been a response to the approval request email from the first approver. If there has been a response, the process proceeds to step S111; otherwise, the determination in step S110 is periodically repeated. In step S111, the CPU 101 determines whether the received response indicates approval. If it has been approved, the process proceeds to step S115, and the CPU 101 executes the fax transmission job and then proceeds to step S113. Meanwhile, if it has not been approved, the process proceeds to step S112, and the CPU 101 cancels the fax transmission job and then proceeds to step S113. In step S113, the CPU 101 functions as a result transmission unit; determines whether or not the job is a fax-for-approval transmission job; if the job is a fax-for-approval transmission job, proceeds to step S114; communicates the approval result and the communication result to the in-house address and the mobile address of the approver; and then ends the process. Meanwhile, if the job is not a fax-for-approval transmission job, the process is directly ended.

As described above, the communication apparatus according to the present embodiment receives a fax transmission and acquires the presence information of the first approver who approves the received fax transmission. When the acquired presence information indicates that the approval process by the first approver is possible, the communication apparatus communicates a request for fax transmission approval to the first destination. Meanwhile, when the acquired presence information indicates that the approval process by the first approver is not possible or unknown, the communication apparatus communicates a request for fax transmission approval to a second destination in addition to the first destination. Thereafter, upon receiving a response approving the fax transmission, the communication apparatus executes the fax transmission. Note that it is preferable that the first destination is a destination for the fixed terminal of the first approver and the second destination is a destination for the mobile terminal of the first approver. Thus, according to the present invention, a communication destination of an approval request in a fax transmission can be suitably switched in accordance with the presence information of an approver, and even when the approver cannot immediately process approval due to being in a meeting, being out, or the like, it is possible to reduce time wasted in switching to another approver.

### Second Embodiment

### (Workflow)

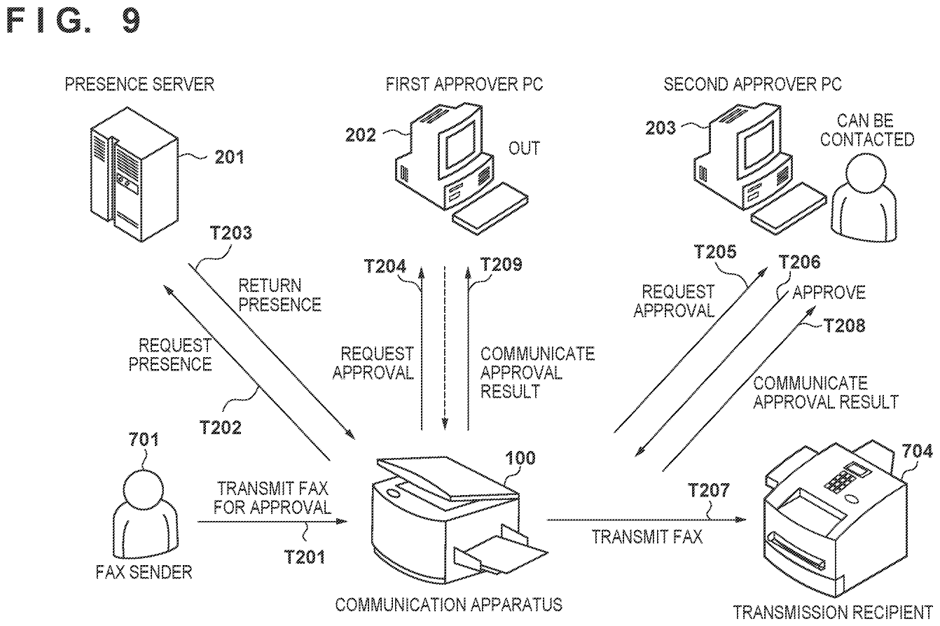

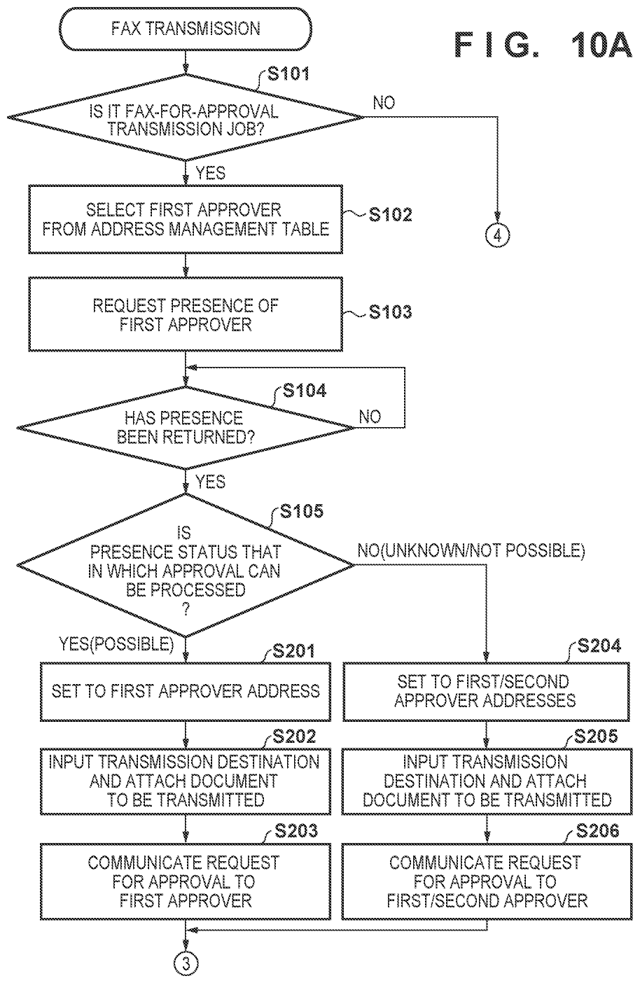

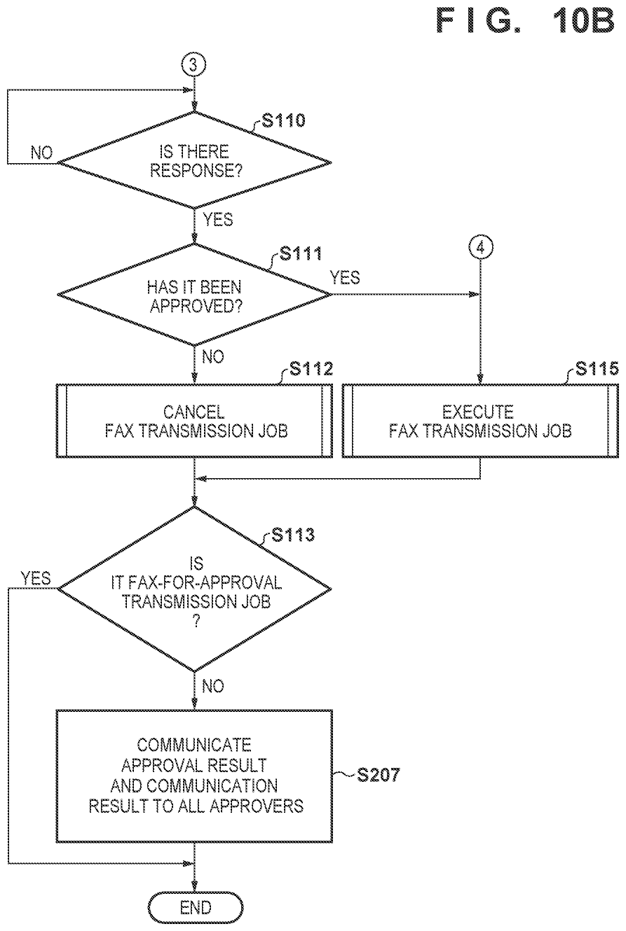

Hereinafter, the second embodiment of the present invention will be described with reference to FIGS. 9 and 10. In this embodiment, unlike the first embodiment described above, when it is determined that the approval process by the first approver is difficult, an approval request is communicated to a second approver, who is different from the first approver, in addition to the first approver. Note that description of the configurations and controls that are the same as those of the above first embodiment will be omitted. That is, description will be omitted for FIGS. 3 to 6 since they are the same as those of the above first embodiment. First, a workflow of a fax-for-approval transmission in the communication system according to the present embodiment will be described with reference to FIG. 9. The solid arrows illustrated in FIG. 9 represent the operations/communication that were actually performed, and a dashed line represents the operation/communication that was not performed.

First, in T201, the fax sender 701 inputs a fax-for-approval transmission job for which the transmission destination and the document to be transmitted needs to be approved to the communication apparatus 100. The FAX sender 701 may input the fax-for-approval transmission job to the communication apparatus 100 via an apparatus such as a PC or via the operation panel 106 of the communication apparatus 100. In the former case, the communication apparatus 100 accepts designation of the job and the document to be transmitted and data itself by the network I/F 113 via the intranet 200. Meanwhile, in the latter case, the communication apparatus 100 receives designation of the job and the document to be transmitted via the operation panel 106. In either case, data stored in advance in the communication apparatus 100 or data read by the scanner 108 may be used as the data to be transmitted.

Next, in T202, the communication apparatus 100 inputted with the fax-for-approval transmission job queries the presence server 201 for the presence status of the first approver using the identification information of the first approver. The presence server 201 acquires the presence status of the first approver for whom the query has been made from the presence status of each approver being managed using the received identification information of the first approver and communicates it. Subsequently, in T203, the communication apparatus 100 receives from the presence server 201 the presence status of the first approver for whom the query has been made.

In T204 and T205, the communication apparatus 100 simultaneously communicates an approval request to the first approver (first approver PC 202) and if the received presence status of the first approver is out, additionally to the second approver PC 203 of the second approver. Since the first approver is out, the approval process is not executed, and the approval process is executed by the second approver in T206. When the approval is performed as a result of the approval process by the second approver, the communication apparatus 100 performs fax transmission to the transmission destination in T207. Upon completion of the fax transmission, in T208 and T209, the communication apparatus 100 communicates and shares the approval result and the fax transmission result to all approvers (here, the first approver and the second approver) to whom the approval request was made.

(Processing Procedure of Communication Apparatus)

Next, a processing procedure of a fax transmission in the communication apparatus 100 according to the present embodiment will be described with reference to FIGS. 10A and 10B. The process described below is realized by, for example, the CPU 101 reading the programs stored in the ROM 102 to the RAM 103 and executing these. Note that the same step numbers are assigned to the processes that are the same as those in the flowchart of FIGS. 8A and 8B described in the above first embodiment, and descriptions thereof will be omitted. That is, the same process as in the above first embodiment will be performed in steps S101 to S105, S110 to S113, and S115.

If it is possible 603 for the first approver to execute the approval process in step S105, the process proceeds to step S201, and the CPU 101 sets the in-house address of the first approver as the destination of the approval request. Furthermore, in step S202, the CPU 101 states the transmission destination information in the approval request email, attaches the document to be transmitted, and in step S203, communicates the approval request email to the address of the set approver. Thereafter, the process proceeds to step S110.

Meanwhile, if it is difficult to execute the approval process (unknown 604 or not possible 605) in step S105, the process proceeds to step S204, and the CPU 101 sets the address of the second approver as the destination of the approval request in addition to the address of the first approver. Next, in step S205, the CPU 101 states the transmission destination information in the approval request email, attaches the document to be transmitted, and in step S206, communicates the approval request email to the address of the set approver. Thereafter, the process proceeds to step S110.

In addition, if it is determined that the job is a fax-for-approval transmission job in step S113, the process proceeds to step S207, and the CPU 101 functions as a result transmission unit, communicates the approval result and the communication result to all the approvers, and then ends the process. In other words, if the approval request has been communicated to only the first approver in step S203, the results are communicated to the first approver, and the approval request has been communicated to the first approver and the second approver in step S206, the results are communicated to both the first approver and the second approver. This can prevent repetitive approval such as the case where the second approver grants approval but then the first approver grants another approval upon returning.

As described above, according to the communication apparatus of the present embodiment, the first destination to which an approval request is communicated is the destination for the apparatus of the first approver, and the second destination is the destination for the apparatus of the second approver who different from the first approver. Therefore, even when the approval process by the first approver is difficult, the approval process can be executed by the second approver serving as a proxy, and it becomes possible to prevent fax transmission from being delayed.

<Variations>

Note that regarding a case where the approval of the first approver is determined to be unknown or not possible based on the presence status, an example in which an approval request is communicated to a plurality of addresses of one approver (first approver) has been described in the above the first embodiment. In addition, regarding in such a case, an example in which an approval request is communicated to a plurality of approvers (first approver and second approver) has been described in the above second embodiment. However, the present invention is not limited only to these embodiments, and several variations are possible.

For example, the above first and second embodiments can be combined. In this case, an approval request is communicated to a plurality of addresses of the first approver and the approval request is also communicated to the second approver. Furthermore, the presence status of the second approver may be queried from the presence server 201, and if it is determined that the presence status of the second approver is unknown or not possible, communication may be made, if there are several, to all of the addresses of the second approver. In the above embodiments, an example in which the first approver and the second approver are registered has been described, but a plurality of approvers may be registered. Furthermore, in the above embodiments, the approval request is communicated to the second destination in addition to the first destination, but communication may be made not to the first destination and only to the second destination. Further, the selection method of these communication destinations may be switched via settings.

In the above embodiments, examples in which the communication apparatus 100 communicates to a plurality of approvers have been described. However, in the present invention, a mechanism in which an approval request is first communicated to only the first approver as in the above first embodiment and in that approval request email, the first approver instructs a request to another approver may be provided. In this case, an email simply instructing a request to another approver may be returned to the communication apparatus 100 as a response, and the communication apparatus 100 may request again to the designated approver. As a result, the first approver can select and designate another approver in accordance with the content of the document (fax transmission data) of the approval request.

According to the present invention, a communication destination of an approval request in a fax transmission can be suitably switched in accordance with the presence information of an approver, and even when the approver cannot immediately process approval due to being in a meeting, being out, or the like, it is possible to reduce time wasted in switching to another approver.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-200506, filed Dec. 2, 2020, which is hereby incorporated by reference herein in its entirety.

What is claimed is:

1. A data transmitting apparatus, comprising:
an approval request transmission unit configured to transmit an approval request for transmission of data; and
a data transmission unit configured to transmit the data on the basis of receiving an approval response approving the transmission of the data as a response to the approval request transmitted by the approval request transmission unit,
wherein the approval request transmission unit changes a destination of the approval request based on presence information of an approver who approves the transmission of the data.

2. The data transmitting apparatus according to claim 1, wherein
in a case where the presence information indicates that an approval process by a first approver is possible, the approval request is transmitted to a first destination, and in a case where the presence information indicates that the approval process by the first approver is not possible or unknown, the approval request is transmitted to a second destination.

3. The data transmitting apparatus according to claim 2, wherein
the case where the presence information indicates that the approval process by the first approver is possible is a case where the presence information indicates that contact is possible.

4. The data transmitting apparatus according to claim 2, wherein
the case where the presence information indicates that the approval process by the first approver is possible is a case where the presence information indicates away.

5. The data transmitting apparatus according to claim 2, wherein
the case where the presence information indicates that the approval process by the first approver is not possible is a case where the presence information indicates out.

6. The data transmitting apparatus according to claim 2, wherein
the case where the presence information indicates that the approval process by the first approver is not possible is a case where the presence information indicates offline.

7. The data transmitting apparatus according to claim 1, wherein
the presence information is received from a server.

8. The data transmitting apparatus according to claim 1, wherein
the transmission of the data is transmission of data by a fax machine.

9. The data transmitting apparatus according to claim 1, wherein
the approval request transmission unit transmits the approval request by email.

10. A data transmitting apparatus, comprising:
an acquisition unit configured to acquire presence information; and
a control unit configured to change a transmission destination of data based on the presence information acquired by the acquisition unit.

11. The data transmitting apparatus according to claim 10, wherein
in a case where the presence information is first information, the data is transmitted to the first destination, and in a case where the presence information is second information different from the first information, the data is transmitted to the second destination.

12. The data transmitting apparatus according to claim 11, wherein
the first information is information indicating that contact is possible.

13. The data transmitting apparatus according to claim 11, wherein
the second information is information indicating out.

14. The data transmitting apparatus according to claim 11, wherein
the control unit changes a transmission destination of data by email based on the presence information acquired by the acquisition unit.

15. A method of controlling a data transmitting apparatus, the method comprising:
transmitting an approval request for transmission of data; and
transmitting the data on the basis of receiving an approval response approving the transmission of the data as a response to the transmitted approval request,
wherein a destination of the approval request is changed based on presence information of an approver who approves the transmission of the data.

16. A non-transitory storage medium operable to store a program for causing a computer to execute each process of a method of controlling a data transmitting apparatus, the method comprising:
transmitting an approval request for transmission of data; and
transmitting the data on the basis of receiving an approval response approving the transmission of the data as a response to the transmitted approval request,
wherein a destination of the approval request is changed based on presence information of an approver who approves the transmission of the data.
